(19) United States
(12) Patent Application Publication
(10) Pub. No.: US 2026/0155345 A1
(43) Pub. Date: Jun. 4, 2026

(54) BATTERY AND METHOD OF MANUFACTURING BATTERY

(71) Applicant: SAMSUNG SDI CO., LTD., Yongin-si (KR)

(72) Inventors: Donghyun KIM, Yongin-si (KR); Yejin SEO, Yongin-si (KR); Eunjeong MOON, Yongin-si (KR)

(21) Appl. No.: 19/233,308

(22) Filed: Jun. 10, 2025

(30) Foreign Application Priority Data
Dec. 4, 2024 (KR) 10-2024-0178555

(51) Int. Cl. H01M 4/04; H01M 10/04; H01M 50/105; H01M 50/169; H01M 50/188

(52) U.S. Cl. CPC H01M 4/0416; H01M 10/0481; H01M 10/049; H01M 50/169; H01M 50/105; H01M 50/188

(57) ABSTRACT

A pouch-type battery manufacturing method includes mounting an electrode assembly in a case, the electrode assembly including a first electrode, a second electrode, and a separator interposed between the first electrode and the second electrode. Room for gas is formed on opposite sides of the electrode assembly in the case, and the electrode assembly is impregnated with an electrolyte.

### CROSS-REFERENCE TO RELATED APPLICATION

This application claims priority under 35 U.S.C. § 119 to Korean Patent Application No. 10-2024-0178555, filed in the Korean Intellectual Property Office on Dec. 4, 2024, the entire contents of which are hereby incorporated by reference.

### BACKGROUND

### Field

The present disclosure relates to a battery manufacturing method with which a battery cell is effectively impregnated with an electrolyte and a battery manufactured by the method.

### Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

When a battery cell is placed in a case, various issues occur such as gas generation during an electrolyte impregnation process, which may reduce impregnation efficiency and cause there to be unimpregnated areas. Such issues may cause decreased capacity, increased internal resistance, slower charging and discharging rates, thermal instability, shorter battery life, and safety concerns. Therefore, enhancements to the manufacturing process for effectively impregnating an electrolyte are desired.

The above information disclosed in this Background section is for enhancement of understanding of the background of the present disclosure, and therefore, it may contain information that does not constitute related (or prior) art.

### SUMMARY

The present disclosure provides a battery manufacturing method for forming a structure where an electrolyte flows in an impregnation process to allow the electrolyte to be effectively impregnated into a battery cell and a battery manufactured by the method.

These and other aspects and features of the present disclosure will be described in or will be apparent from the following description of embodiments of the present disclosure.

According to embodiments of the present disclosure, there is provided a battery manufacturing method including mounting an electrode assembly in a case, with the electrode assembly including a first electrode, a second electrode, and a separator interposed between the first electrode and the second electrode, forming room for a gas room on opposite sides of the electrode assembly in the case, and impregnating the electrode assembly with an electrolyte.

According to embodiments of the present disclosure, the mounting of the electrode assembly in the case may include shaping to form a cell room in which electrode assembly is mounted.

According to embodiments of the present disclosure, the method may further include perforating a tab exposure part that exposes electrode tabs adjacent to the cell room, each of the tabs connected to one of the first electrode and the second electrode to outside of the case.

According to embodiments of the present disclosure, the method may further include coupling a case cover onto the case and pressurizing the room for gas to cause a flow of an electrolyte.

According to embodiments of the present disclosure, the gas room may include a first gas room and a second gas room formed on both sides of the electrode assembly, wherein the pressurizing of the gas room includes pressurizing the first gas room or the second gas room by using a pressure plate.

According to embodiments of the present disclosure, the gas room may include a first gas room and a second gas room formed on both sides of the electrode assembly, wherein the pressurizing of the gas room includes pressurizing the first gas room and the second gas room, respectively, by using a first pressure plate and a second pressure plate.

According to embodiments of the present disclosure, the first pressure plate and the second pressure plate may be alternately used to pressurize the first gas room and the second gas room.

According to embodiments of the present disclosure, the first electrode may be connected to a first electrode tab, and the second electrode is connected to a second electrode tab, wherein the gas room includes a first gas room formed on a first side surface where the first electrode tab and the second electrode tab are provided, and a second gas room formed on a second side surface opposite to the first side surface.

According to embodiments of the present disclosure, the coupling of the case cover to the case may include forming an edge sealing part sealed where the case and the case cover overlap, and forming a tab sealing part extending from the edge sealing part and sealing a periphery of electrode tabs connected to the first electrode and the second electrode of the electrode assembly.

According to embodiments of the present disclosure, the tab sealing part may include a passage formed on a side surface of the electrode assembly where the electrode tabs are provided.

According to embodiments of the present disclosure, the pressurizing of the gas room may be performed when the case in a horizontal plane.

According to embodiments of the present disclosure, the coupling of the case cover onto the case may include bonding the case to the case cover by thermal fusion.

According to embodiments of the present disclosure, the method may further include, after pressurizing of the gas room, tilting the case to allow gas inside the case to move upward, perforating a surface of the case to exhaust the gas, sealing between a part of the case from which the gas is removed in the case and another part of the case, and cutting and removing the part of the case from which the gas is removed.

According to embodiments of the present disclosure, the method may further include after cutting and removing the part of the case from which the gas is removed, reverse-tilting the case in a direction opposite to a direction the case was tilted, sealing the case to separate a part that accommodates the electrode assembly from areas another part of the case, and cutting and removing the areas another part of the case.

According to embodiments of the present disclosure, the method may further include folding a sealed area that remains at an edge of the case after the areas another part of the case is removed.

According to embodiments of the present disclosure, the sealing of the case to separate the part accommodating the electrode assembly from the another part of the case may include sealing a passage formed on a side surface where an electrode tab is formed.

According to embodiments of the present disclosure, the exhausting of the gas inside the case may include connecting an exhaust hole formed by perforating a surface of the case to an external device and exhausting the gas by creating a vacuum environment using the external device.

According to embodiments of the present disclosure, the case may be formed by a pouch-type fabric.

According to embodiments of the present disclosure, the case may be formed from stainless use steel (SUS).

According to embodiments of the present disclosure, there is provided a battery manufactured by using the battery manufacturing method, wherein the battery may include a sealing part on a side surface opposite to a side surface where an electrode tab of the battery is exposed.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a flowchart of steps of an impregnation process according to embodiments of the present disclosure;

FIG. 2 illustrated a pouch including a first fabric and a second fabric to be bonded according to embodiments of the present disclosure;

FIG. 3 is a view of room for a cell in a second fabric according to embodiments of the present disclosure;

FIG. 4 is a view of room for a cell and room for gas in a second fabric according to embodiments of the present disclosure;

FIG. 5 is a view of room for a cell, room for gas, and a tab exposure part in a second fabric according to embodiments of the present disclosure;

FIG. 6 is a view of a first fabric and a second fabric bonded to each other by a sealing when a cell is mounted according to embodiments of the present disclosure;

FIG. 7 is a view of a second fabric showing a sealing part, a first enlarged area, and a second enlarged area from a side according to embodiments of the present disclosure;

FIG. 8 is a view of a first enlarged area according to embodiments of the present disclosure;

FIG. 9 is a view of a second enlarged area according to embodiments of the present disclosure;

FIG. 10 is a view of room for gas that is pressurized by a first pressure plate according to embodiments of the present disclosure;

FIG. 11 is a view of room for a gas that is pressurized by a second pressure plate between a first pressure plate and the second pressure plate provided according to embodiments of the present disclosure;

FIG. 12 is a view of room for a gas that is pressurized by a first pressure plate and a second pressure plate provided according to embodiments of the present disclosure;

FIG. 13 is a view of room for a gas oriented upright in a vertical direction (Z direction) and pressurized by a first pressure plate according to embodiments of the present disclosure;

FIG. 14 is a flowchart of a pouch processing step according to embodiments of the present disclosure;

FIG. 15 is a cross-sectional view of a pouch bonded by a sealing part, and a view of a state where gas is captured upward according to embodiments of the present disclosure;

FIG. 16 is a cross-sectional view of a pouch bonded by a sealing part, and a view of gas exhausted through a perforated exhaust hole according to embodiments of the present disclosure;

FIG. 17 is a cross-sectional view of a pouch bonded by a sealing part, and a view of a first cutting part, where gas is collected and is removed according to embodiments of the present disclosure;

FIG. 18 is a cross-sectional view if a pouch bonded by a sealing part, and a view of a current collector according to embodiments of the present disclosure;

FIG. 19 is a cross-sectional view of a pouch bonded by a sealing part, and a view of a second cutting part that accommodates an excess electrolyte according to embodiments of the present disclosure;

FIG. 20 is a cross-sectional view of a pouch bonded by a sealing part, and a view of a third cutting part placed at an edge according to embodiments of the present disclosure;

FIG. 21 is a plan view and a side view of a battery; and

FIG. 22 is a view of a sealing part of a folded battery according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

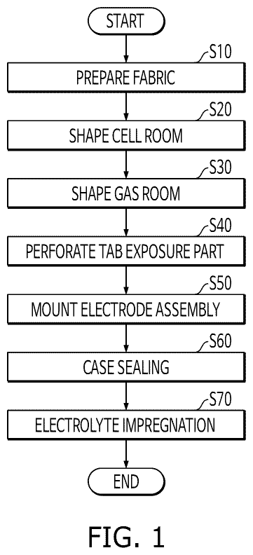

FIG. 1 is a flowchart of an impregnation process according to embodiments of the present disclosure.

A battery manufacturing method according to embodiments of the present disclosure may include mounting an electrode assembly including a first electrode, a second electrode, a separator interposed between the first electrode and second electrode in a case, forming room for gas on both sides of the electrode assembly in the case, and impregnating the electrode assembly with an electrolyte. The manufacturing method of a pouch-type battery will be described below, but the battery manufacturing method of the present disclosure may be applied to other various batteries such as a square-type battery.

Referring to FIG. 1, a battery manufacturing method according to embodiments may include preparing fabrics in step S10, shaping room for a cell rooms in step S20, shaping room for gas in step S30, perforating a tab exposure part in step S40, mounting an electrode assembly in step S50, sealing a case in step S60, and impregnating an electrolyte in step S70.

The step of preparing the fabrics in step S10 may include preparing a case that accommodates an electrode assembly 200 therein and a case cover. The case and the case cover may be fabrics that form a pouch.

The step of forming the room for the cell in step S20 may include shaping the fabric to provide a space for an electrode assembly in one of a case cover or a case. The cell room may be partially formed in both the case cover and the case so that when the case cover and the case are bonded, the electrode assembly may form the full room for the electrode assembly. The specific method of forming the room in the cell is not limited in the present disclosure.

The step of forming the room for gas in step S320 may include room on both sides of the room for the cell. A first gas room may be formed on one side of the cell room, and a second gas room may be formed on the other side of the cell room.

The step of perforating the tab exposure part in step S40 may include forming the perforated tab exposure part to expose electrode tabs connected to a first electrode and a second electrode of the electrode assembly to outside of the case.

The step of mounting the electrode assembly in step S50 may include mounting the electrode assembly in the room for the cell. The electrode assembly may include a first electrode, a second electrode, and a separator interposed between the first electrode and the second electrode. The electrode assembly may be a wound type or a stacked type, and the present disclosure is not limited in this regard.

The step of sealing the case in step S60 may include sealing the electrode assembly mounted in the cell room such that the electrode assembly is sealed from the outside of the battery. For example, the case may be sealed by thermally fusing the case cover and the case such that the two structures are bonded to each other.

The step of impregnating the electrolyte in step S70 may include injecting an electrolyte into the inside of the case to allow the electrode assembly to be impregnated into an electrolyte. The injection of the electrolyte may be performed through an electrolyte injection port.

The step of impregnating the electrolyte in step S70 may include increasing the pressure in the room for gas to thereby cause a smooth flow of the electrolyte. The pressure in either of the first gas room and the second gas room formed at the sides of the cell room or the electrode assembly, or the pressure may be increased in either the first gas room or the second gas room to effectively impregnate an electrolyte into the electrode assembly. When to increase the gas pressure, a pressure plate may be used.

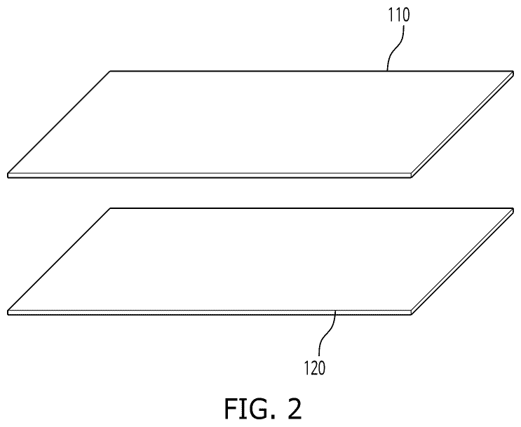

The steps of the method may or may not be sequentially performed. The steps will be described in detail with reference to FIG. 2 to FIG. 13.

FIG. 2 is a view of a case 120 including a case cover 110 and a case 120 bonded to each other according to embodiments of the present disclosure.

Referring to FIG. 2, the step of preparing the fabrics in step S10 may include preparing a case cover 110 and a case 120. The exterior of a battery 10 may be formed by coupling the case cover 110 and the case 120. The case cover 110 and the case 120 may be made of a material that is shaped by sealing, punching, etc. For example, the case cover 110 and the case 120 may be made of a material including at least one of aluminum foil, nylon, and polypropylene, or may be a material including stainless steel (SUS). The coupling between the case cover 110 and the case 120 may be made by heat welding. A sealing part may be formed in the area welded by heat welding. In a particular example, the coupling between the case cover 110 and the case 120 may be performed by a laser welding.

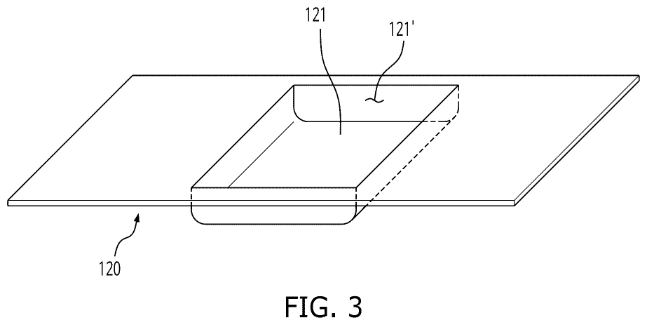

FIG. 3 is a view of a cell room 121 shaped in a case 120 according to embodiments of the present disclosure.

Referring to FIG. 3, a cell room 121 may be formed in at least one of the case cover 110 and the case 120. In the depicted embodiment, the cell room 121 is formed in the case 120. Thus, space 121′ where the electrode assembly 200 is placed may be formed in one area of the case 20, for example, in the center.

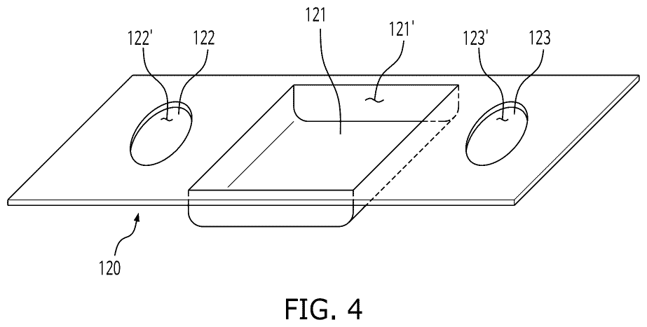

FIG. 4 is a view of room 121 for a cell and room for gas formed in the case 120.

Referring to FIG. 4, room for gas may be provided on both sides of the centered the cell room 121. The gas rooms may include a first gas room 122 formed on a first side and a second gas room 123 formed on a second side with respect to the cell room 121.

A fluid including an electrolyte and a reaction gas may be accommodated inside the room for gas when the case cover 110 and the case 120 are bonded by a sealing, etc. The pressure in the gas room may be increased by an external force to cause the fluid to flow. That is, the fluid in the pouch may flow by pressurization inside of the pouch.

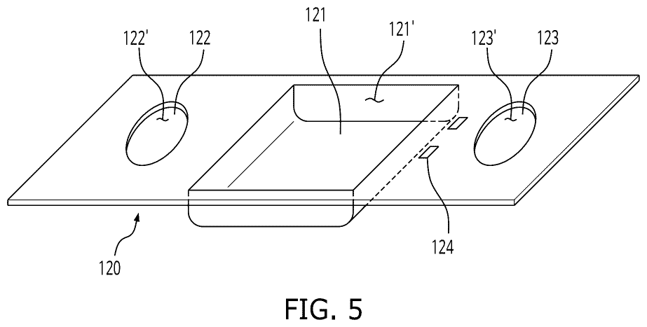

FIG. 5 is a view a cell room 121, a gas room, and a tab exposure part 124 in a case 120.

Referring to FIG. 5, the step of perforating the tab exposure part may be performed so that electrodes tabs adjacent to the cell room 121 are exposed and then connected to a first electrode and a second electrode of the electrode assembly. That is, a first electrode tab and a second electrode tab extend through the tab exposure part 124 to outside of the pouch. The perforated tab exposure part 124 may be provided on a side at ends on the case 120 with respect to the cell room 121. The tab exposure part 124 may allow at least part of the electrode tab of the electrode assembly to be outwardly exposed. Therefore, the tab exposure part 124 may be formed in a section where the electrode tab extends from the electrode assembly. The width of the tab exposure part 124 may be greater than the width of the electrode tab to be exposed to the outside of the pouch.

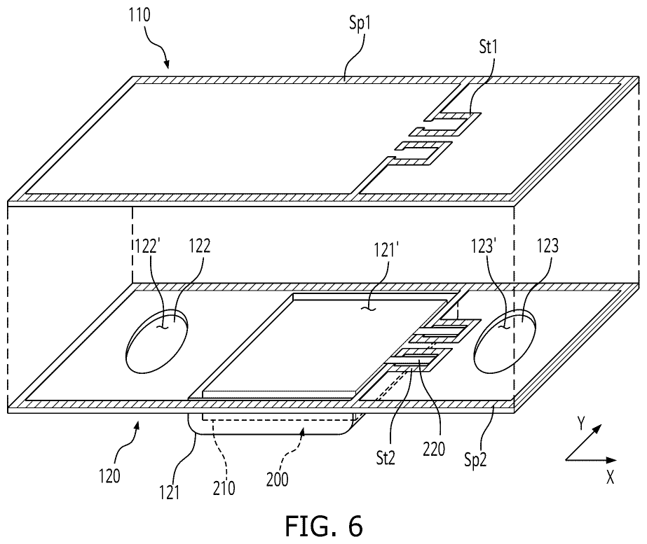

FIG. 6 is a view of a case cover 110 and a case 120 that are bonded to each other by a sealing with an electrode assembly 200 mounted in a cell room 121.

The step of coupling the case cover 110 to the case 120 may include forming a tab sealing part St that seals an edge sealing part along the edge where the case 120 and the case cover 110 overlap. Further, a periphery part extending from the edge sealing part may be connected to each of the first electrode and the second electrode of the electrode assembly 220.

Specifically, referring to FIG. 6, the electrode assembly 200 may be mounted in the cell room 121 formed in the case 120. The case cover 110 and the case 120 may be sealed at the edges while in contact with each other to accommodate the electrode assembly 200. The sealed area may be a case sealing part Sp, which allows the inner space of the case 120 to be airtight from the outside. The case sealing part Sp as shown in FIG. 6, may include a first case sealing part Sp1 on the case cover 110 and a second case sealing part Sp2 on the case 120.

The sealing part formed on the case 120 may further include a tab sealing part St1 and St2 in addition to the case sealing part Sp1 and Sp2. The tab sealing part St1 and St2 may extend from the case sealing part Sp1 toward the electrode tab 220 placed on the inside the case sealing part Sp1 and Sp2. The periphery of a pair of electrode tabs 220 (i.e., a first electrode tab and a second electrode tab) may be sealed by the tab sealing part St1 and St2. The tab sealing part may include a first tab sealing part St1 formed on the case cover 110, and a second tab sealing part St2 formed on the case 120.

However, according to other embodiments, at least part of the space between the pair of the electrode tabs 220 may not be sealed. And, as described below, an electrolyte may flow through the unsealed space between the pair of electrode tabs 220.

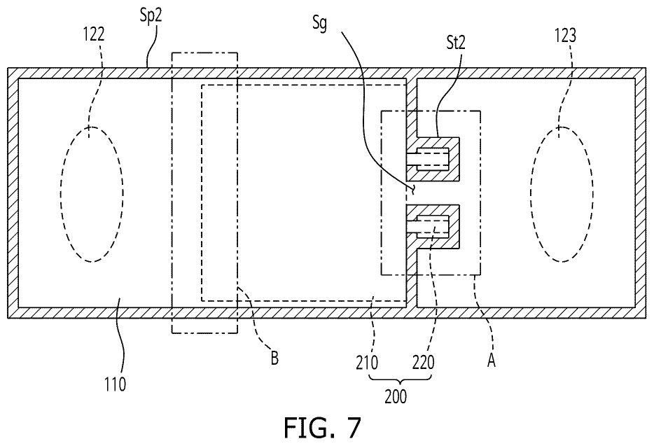

FIG. 7 is a view of a case 120 with a sealing part, a first enlarged area, and a second enlarged area as viewed from a planar perspective.

Referring to FIG. 7, the space between the electrodes 220 may be opened without sealing. Therefore, the space may function as a passage Sg to allow an electrolyte and gas to flow. In particular, the unsealed space between the electrode tabs 220 may be the passage Sg through which the electrolyte and gas flow between the second gas room 123 and the cell room 121. The passage Sg may be formed on a side surface of the electrode assembly in which the electrode tab 220 is formed. But the passage Sg is not limited to being formed in the space between a pair of electrode tabs 220.

The fluid including the electrolyte and gas may flow in the direction from the first gas room 122 to the second gas room 123 or in the direction from the second gas room 123 to the first gas room 122. Thus, the electrolyte may pass through the electrode assembly 200 placed in the cell room 121 by movement in two directions.

For the flow of the electrolyte and gas, the passage Sg may be provided between the cell room 121 and the second gas room 123, and the interface area between the first gas room 122 and the cell room 121 may be an open structure.

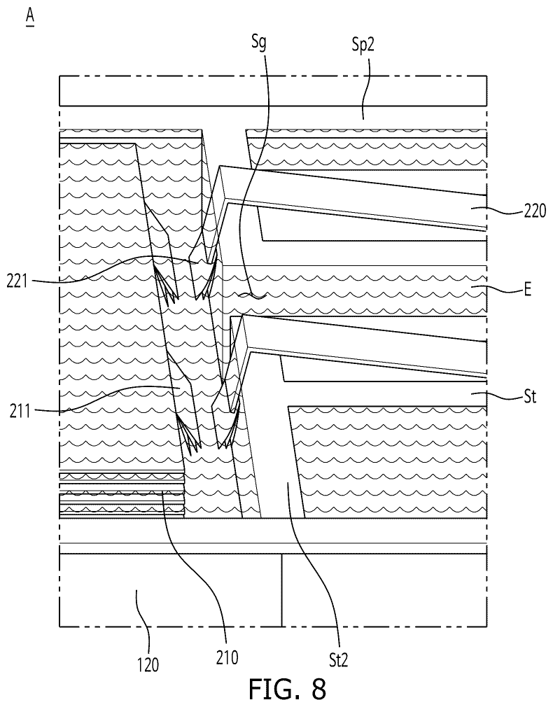

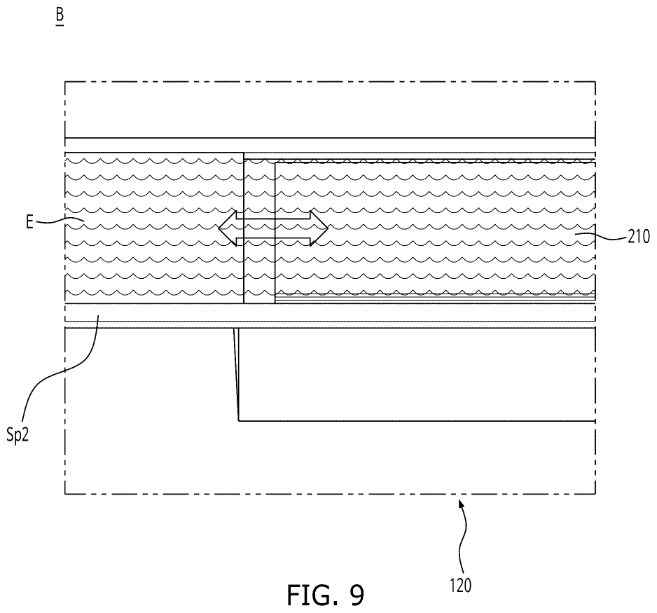

FIG. 8 is a view illustrating a first enlarged area according to embodiments of the present disclosure. FIG. 9 is a view illustrating a second enlarged area according to embodiments of the present disclosure.

Referring to FIG. 8, a first enlarged area A may be provided between the cell room 121 and the second gas room 123 so that an electrolyte E may flow between the cell room 121 and the second gas room 123. Specifically, a pair of second tab sealing parts St2 inwardly extending from the second case sealing part Sp2 may be spaced apart from each other to form the passage Sg in the form of an open space.

Referring to FIG. 9, only the case sealing part Sp formed at the edge may be provided between the case 120 and the case cover 110 in the second enlarged area B. Thus, fluid may flow between the first gas room 122 and the cell room 121 through a gap inside the case and the case cover. The case 120 and the case cover 100 may be sealed while in close contact with each other, but a predetermined amount of elastic deformation may occur due to hydraulic pressure. And the flow of fluid may be increased because of the space created by the elastic deformation. As increased fluid flow occurs, i.e. a larger amount of electrolyte (E) flow occurs, impregnation through the contact between the electrode assembly 200 and the electrolyte E may be effectively performed.

Without an effect amount of flow of the electrolyte E, the electrode assembly 220 may be unevenly impregnated, or may not be impregnated. For example, when the electrode tab 220 is positioned upward in a horizontal direction, during aging, the side surface portion (both side surfaces with respect to the electrode tab 220) may be impregnated first, and the impregnated area may expand toward the center. However, the center may not be impregnated or insufficiently impregnated during a predetermined time (e.g., 30 hours) to complete the aging.

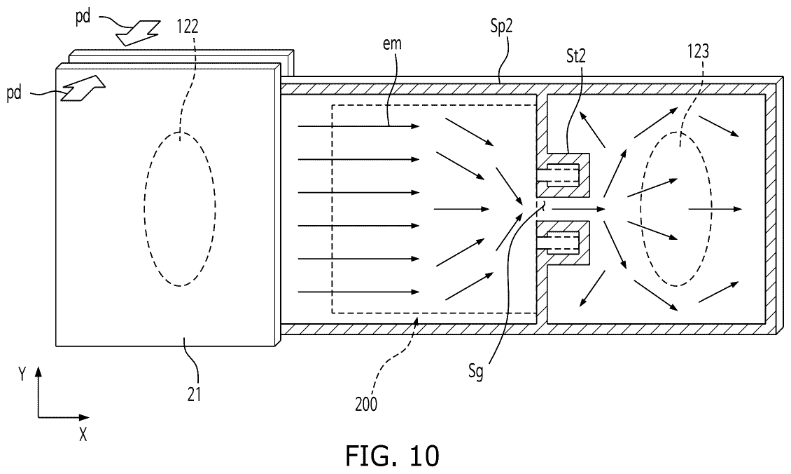

FIG. 10 is a view illustrating a first gas room 122 in which pressure is increased by a first pressurized plate 21 according to embodiments of the present disclosure.

A battery manufacturing method according to embodiments may include coupling the case cover 110 onto the case 120 and increase pressure in a gas room to cause the flow of the electrolyte (E).

Referring to FIG. 10, the step of increasing pressure in the gas room 122 or the second gas room 123 may be effectuated by the first pressure plate 21. The first pressure plate 21 may apply pressure to the first gas room 122. For example, the case and the case cover may be arranged on an XY plane, and the gas room may face downward or upward, and the first pressure plate 21 may apply pressure in a Z direction that is perpendicular to an X direction and a Y direction.

The increased pressure in the first gas room 122 caused by the first pressure plate 21 may cause the fluid accommodated in the first gas room 122 to move to the cell room 121. Then a portion of the fluid may move to the second gas room 123 if there is a limited accommodation space for the fluid in the cell room 121. The portion of the fluid that moves to the second gas room 123 may move through the passage Sg provided between the tab sealing parts St.

When the first pressurized plate 21 is used in conjunction with the second gas room 123 to increase pressure in the second gas room 123, the flow of the fluid may occur from the second gas room 123 to the first gas room 122. As described above, the fluid may flow unidirectionally from within the case and the case cover by the action of the first pressure plate 21. Further, if the first pressurized plate 21 does not apply pressure, a passage through which the portion of the fluid may be formed by the elastic restoring force of the case 120.

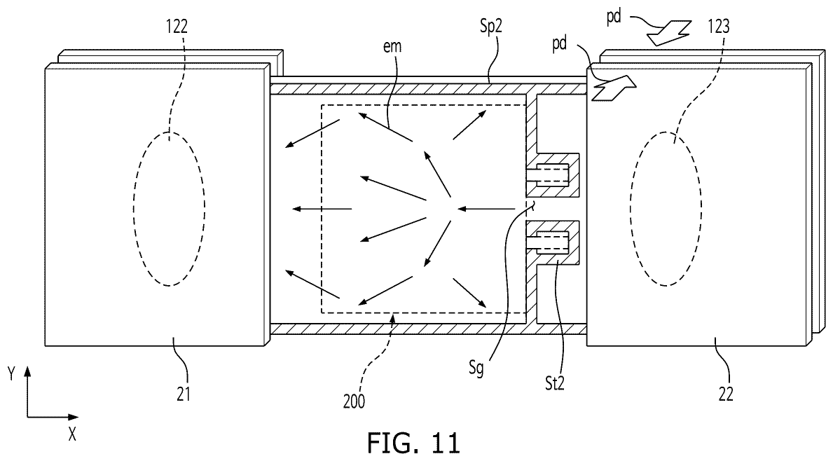

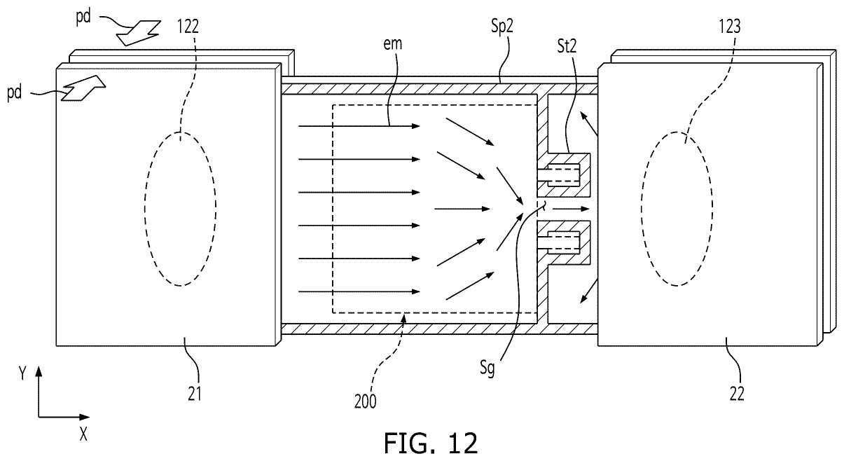

FIG. 11 is a view illustrating a second gas room 123 that is pressurized by a second pressure plate 22. FIG. 12 depicts a first gas room 122 p between a first pressure plate 21 and a second pressure plate 22.

Referring to FIG. 11 and FIG. 12, bidirectional flow of the electrolyte E may occur by pressurizing the first gas room 122 and the second gas room 123 that are provided on opposite sides of the electrode assembly 220 with the electrode assembly 200 placed in the cell room 121 at the center. In the step of increasing pressure, the first gas room 122 may be pressurized by the first pressure plate 21 placed to correspond to the first gas room 122, and the second gas room 123 may be pressurized by the second pressure plate 22 placed to correspond to the second gas room 123.

The first pressure plate 21 and the second pressure plate 22 may not simultaneously apply pressure to the respective gas rooms 122 and 123, but at least one may apply pressure at a time. In other words, the first pressure plate 21 and the second pressure plate 22 may be alternately apply pressure. The alternating cycle may be ten seconds. For example, the time during which the first pressure plate 21 applys pressure to the first gas room 122 may be ten seconds, and the time during which the second pressurized plate 22 applies pressure to the second gas room 123 may be 10 seconds. The alternating cycle may be repeated for one hour. But the pressurizing time may not be limited thereto and may vary depending to the viscosity of the electrolyte (E), the size of the pouch, etc.

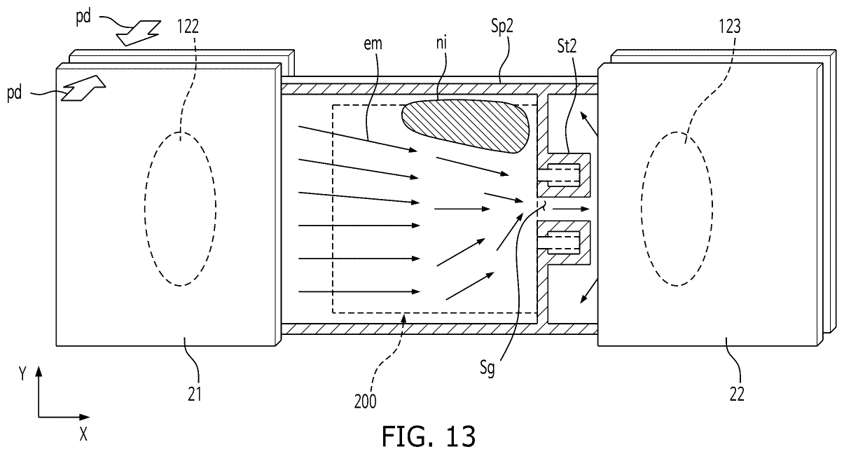

FIG. 13 is a view illustrating that a first gas room 122 is oriented vertically (Z direction) and pressurized by the first pressurized plate 21.

Referring to FIG. 13, the step of pressurizing the gas room may be performed when the case 120 is arranged to be parallel to a horizontal plane (XY plane). In such an arrangement, the gas room may protrude upwardly or downwardly.

As shown in FIG. 13, when the gas room is oriented in the XY direction and impregnated, a non-impregnated area ni may be formed. The fluid accommodated in the pouch may include the gaseous reaction gas and the liquid electrolyte (E), and the reaction gas may rise upwardly. When the fluid flows from the cell room 121 to the second gas room 123, the lower positioned electrolyte E may move through the passage Sg, and the upper positioned reaction gas may be restricted in its movement by the tab sealing part St. Accordingly, the non-impregnated area ni may be formed in the portion of the electrode assembly 200.

But as in FIG. 10 to FIG. 12, in FIG. 13 the components may be arranged to be parallel to a horizontal plane (which is the XY plane) to allow the electrolyte E to flow so that the gas may not be concentrated in a narrow area. The fluid including the reaction gas may flow between the first gas room 122 and the cell room 121, and between the cell room 121 and the second gas room 123, so that the fluid may freely flow by the pressure applied by the first pressure plate 21 and the second pressure plate 22. The step of pressurizing the gas rooms may be performed when the case and the case cover are arranged to be parallel to a horizontal plane.

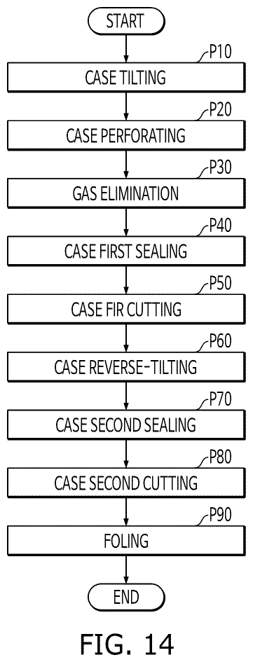

FIG. 14 is a flowchart of a battery manufacturing method according to embodiments of the present disclosure.

After the step of pressurizing the gas room, the method may further include tilting the case 120 and the case cover 110 to face upwardly, exhausting the gas in the case 120 by perforating a surface of the case 120, sealing the area in which the gas is removed in the case 120, and cutting and removing the area where the gas is removed, which is divided by the sealing.

After the step of cutting and removing the area where the gas is removed, the method may further include a step of reverse-tilting the case 120 in a direction opposite to the tilted direction, sealing the case 12 to include an area for accommodating the electrode assembly 200 and other areas, and cutting and removing the other areas.

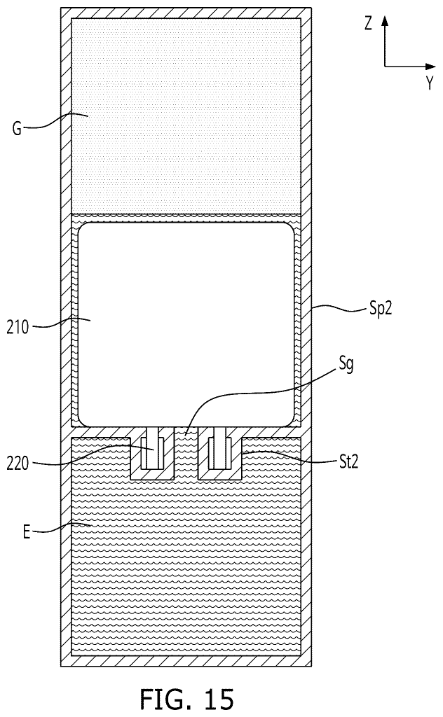

FIG. 14 illustrates the order of steps of a method according to embodiments of the present disclosure. The method may include a tilting step in step P10, a case perforation step in step P20, a gas removal step in step P30, a first case sealing step in step P40, a first case cutting step in step P50, a reverse case tilting step in step P60, a second case sealing step in step P70, a second case cutting step in step P80, and a folding step in step P90. Each step will be described below with reference to FIGS. 15 to 20.

FIG. 15 is a cross-sectional view illustrating the case 120 bonded by the sealing part according to embodiments, with the gas being collected upwardly.

Referring to FIG. 15, the reaction gas may be collected in an upward direction as depicted by tilting a case and a case cover. In this configuration, the case cover and the case are tilted so that the electrode tab 220 may face downwardly with respect to a vertical direction. The amount of the electrolyte E (which moves downwardly due to its own weight) may be such that the electrode assembly 200 is immersed in the electrolyte.

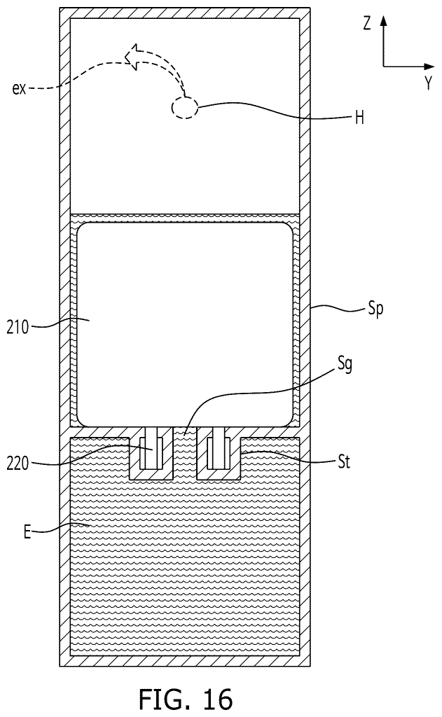

FIG. 16 is a cross-sectional view of the case 120 bonded by the sealing part and showing the gas being exhausted through the perforated exhaust hole H.

Referring to FIG. 16, the step of exhausting the gas in the case 120 may be performed by perforating the surface of the case 120 (or the case cover) to form the exhaust hole H. An external device may be connected and a vacuum may be created by the external device to induce the exhaust of the gas.

Referring to FIG. 16, when the case and the case cover are tilted so that the electrode tab 220 faces downwardly, one of the gas rooms may be perforated. The perforation may be in the upper gas room, which may be the second gas room 123 according to embodiments of the present disclosure. The reaction gas collected in the second gas room 123 may be exhausted along an exhaustion direction ex by way of the exhaust hole H formed to the second gas room 123. The second gas room 123 may be connected to the outside through the exhaust hole H so that the reaction gas inside the second gas room may be naturally exhausted to the outside. In another example, the reaction gas may be suctioned by an exhaust means connected to the exhaustion hole H and exhausted from the second gas room 123.

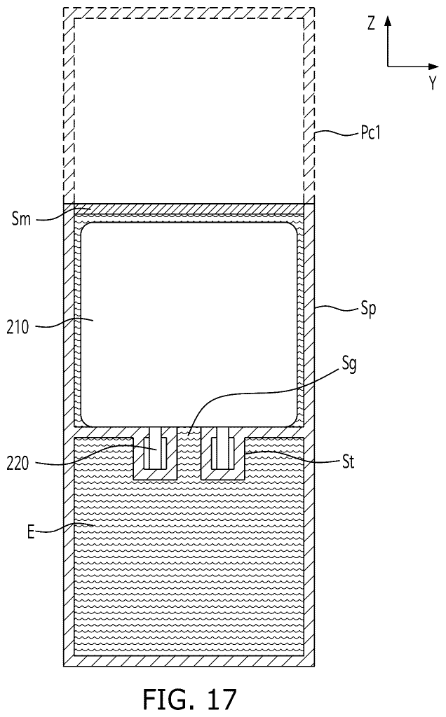

FIG. 17 is a cross-sectional view of the case 120 bonded by a sealing part illustrating a middle sealing part between a cell room and a second gas room, with part of the 120 having been removed by cutting.

Referring to FIG. 17, the gas collected inside the second gas room 123 may be exhausted and sealing may be performed at the interface between the second gas room 123 and the cell room 121. By the sealing, the cell room 121 and the second gas room 123 may be divided by a middle sealing part Sm.

Both ends of the middle sealing part Sm may be connected to the case sealing part Sp to maintain watertightness, thereby sealing the electrolyte E in the case. The electrolyte E may immerse the electrode assembly 200 and fill the space between the cell room 121 and the first gas room 122 that are connected to each other through the passage Sg.

A first cut part Pc1 that included the second gas room 123 may be removed after the middle sealing part Sm is formed.

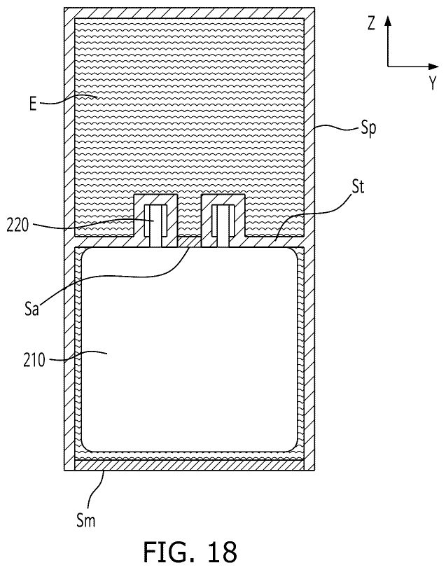

FIG. 18 is a cross-sectional view of the case 120 bonded by the sealing part and illustrating the sealing of a passage.

Referring to FIG. 18, the sealing step may be performed so that the area for accommodating the electrode assembly 200 and the other areas are separated. The passage Sg formed on a first side surface of the electrode assembly 200 (where the electrode tab 220 is provided) may be sealed.

The case and the case cover may be reverse-tilted after the first cut part Pc1 is removed. Here, reverse-titled means tilting after the tilting described above in conjunction with FIGS. 16 and 17. The case and the case cover are oriented such that the electrode tab 220 faces upward. That is, the case and the case cover may be tilted by 180 degrees so that the bottom in the first case-tilting step is at the top. The reverse-tilting may move residual reaction gas in the cell room 121 to the first gas room 122 to thereby remove the reaction gas in the cell room 121.

After the case is reverse-tilted, the passage Sg that connects the first gas room 122 to the cell room 121 may be blocked. For example, the passage Sg may be sealed. In particular, the space formed between the facing tab sealing parts St may be sealed to form a passage sealing part Sa that blocks the passage Sg. Both ends of the passage sealing part Sa may be connected to the end portions of the tab sealing parts St.

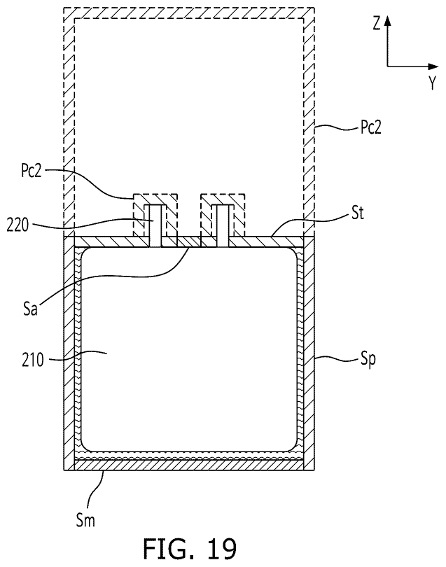

FIG. 19 is a cross-sectional view illustrating the case 120 bonded by the sealing part and illustrates the removement of a second cut part Pc2 in which the residual electrolyte E has accumulated.

Referring to FIG. 19, the second cut part Pc2 that includes the first gas room 122 may be removed. The case and the case cover where the first gas room 122 and the cell 121 are divided by the passage sealing part Sa may have only the area corresponding to the cell 121 that accommodates the electrode assembly 200 after removal of the second cut part Pc2. The cell room 121 be an internal space that is by the passage sealing part Sa, the tab sealing part St, the case sealing part Sp, and the middle sealing part Sm.

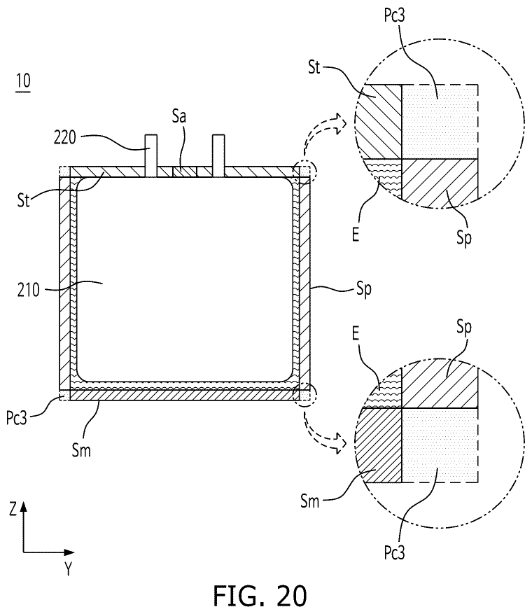

FIG. 20 is a cross-sectional view of the case 120 bonded by the sealing part and illustrates the removal of a third cut part Pc3.

Referring to FIG. 20, the electrolyte E and a jelly roll 210 may be accommodated in the internal space blocked from the outside by the sealing part (the passage sealing part Sa, the tab sealing part St, the case sealing part Sp and the middle sealing part Sm). The end portion of the electrode tab 220 electrically connected to the jelly roll 210 is exposed to the outside.

The third cut parts Pc3, which are corner areas where the sealing part Sm and the case sealing part Sp are connected, may be removed to enable the folding of the middle sealing part Sm and the case sealing part Sp.

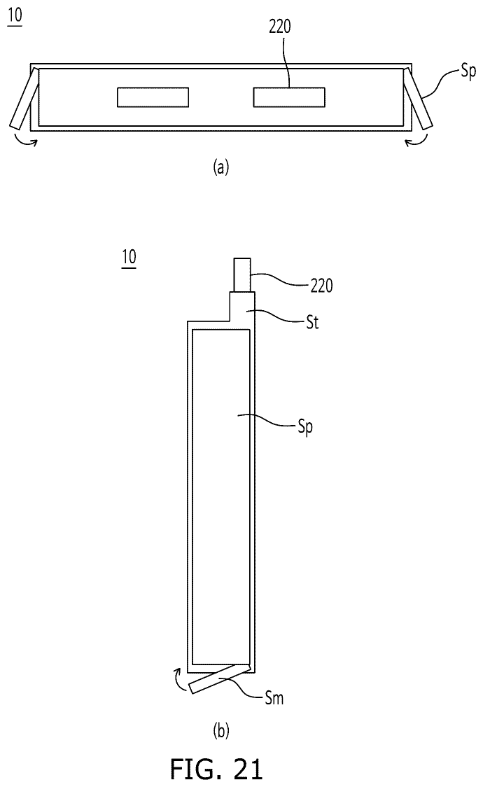

FIGS. 21(A) and 21(B) view of a battery 10 according to embodiments. In particular, FIG. 21 (A) is a view of a side of the electrode tab 220, and FIG. 21(B) is a side view of the battery 10.

After the third cut part Pc3 is removed, a step folding the sealed area remaining at the edge of the case 120 may be performed. Referring to FIG. 21(A) and FIG. 21(B), the case sealing part Sp may be folded to the outer surface of the cell room 121 after removal of the third cut part Pc3. Further, the middle sealing part Sm may be folded to the outer surface of the cell room 121 after removal of the third cutting part Pc3.

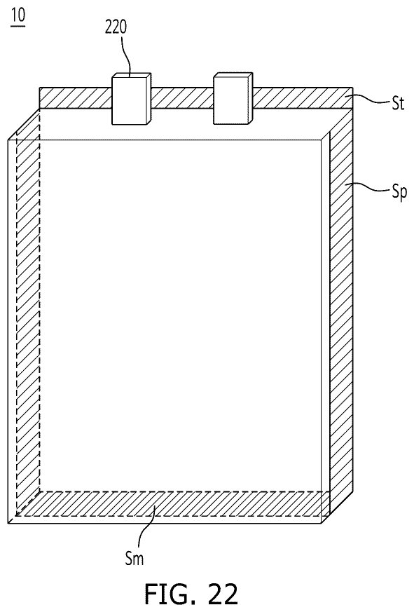

FIG. 22 is a view of a state when the sealing part of the battery 10 is folded.

FIG. 22 illustrates the battery 10 made by the method described above, with the battery 10 including the folded sealing part. The sealing part of the battery 10 may include at least the middle sealing part Sm formed on a second side surface (a side surface opposite to a first side surface where the electrode tab 220 is formed) of the electrode assembly 200. The middle sealing part Sm and the case sealing part Sp may be folded. In addition, the tab sealing part St may be optionally folded.

The case 120 and the case cover 110 of the battery 10 may be formed from a pouch-type fabric. According to another embodiment, the case 120 and the case cover 110 of the battery 10 may be made of a material including stainless steel (Stainless Use Steel, SUS).

### DESCRIPTION OF NOTATIONS

10: Battery
21: First Pressurized Plate
22: Second Pressurized Plate
110: Case Cover
120: Case
121: Cell Room
121′: Cell Room Space
122′: First Gas Room
122′: First Gas Room Space
123: Second Gas Room
123: Second Gas Room Space
124: Tab Exposure Part
200: Electrode Assembly
210′: Jellyroll
211: Jellyroll Terminal
220: Electrode Tab
221 Electrode Tab Terminal
Sp: Case Sealing Part
Sp1: First Case Sealing Part
Sp2: Second Case Sealing Part
St: Tab Sealing Part
St1: First Sealing Part
St2: Second Sealing Part
Sg: Passage
Sm: Middle Sealing Part
Sa: Passage Sealing Part
E: Electrolyte
em: Electrolyte Flow Direction
pd: Pressurized Direction
ni: Non-impregnated Area
ex: Exhaust Direction
H: Exhaust Hole
Pc1: First Cutting Part
Pc2: Second Cutting Part
Pc3: Third Cutting Part
S10: Fabric Preparing
S20: Cell Room Forming
S30: Gas Room Forming
S40: Tab Exposure Part Perforation
S50: Electrolyte Assembly Mounting
S60: Case Sealing
S70: Gas Room Pressurization
Case Sealing
P10: Case Tilting
P20: Case Perforating
P30: Gas Removing
P40: Case First Sealing
P50: Case First Cutting
P60: Case Reverse-Tilting
P70: Case Second Sealing
P80: Case Second Cutting
P90: Folding Step
A: First Enlarged Area
B: Second Enlarged Area

What is claimed is:

1. A battery manufacturing method comprising:
mounting an electrode assembly in a case, the electrode assembly including a first electrode, a second electrode, and a separator interposed between the first electrode and the second electrode;
forming a room for gas on opposite sides of the electrode assembly in the case; and
impregnating the electrode assembly with an electrolyte.

2. The method as claimed in claim 1, wherein the mounting of the electrode assembly in the case includes shaping to form a cell room in which the electrode assembly is mounted.

3. The method as claimed in claim 2, wherein the method further comprises perforating a tab exposure part that exposes electrode tabs adjacent to the cell room, each of the electrode tabs connecting one of the first electrode and the second electrode to outside of the case.

4. The method as claimed in claim 1, further comprising:
coupling a case cover onto the case; and
pressurizing the room for gas to cause a flow of an electrolyte.

5. The method as claimed in claim 4, wherein the room for gas comprises a first gas room and a second gas room formed on both sides of the electrode assembly, and
wherein the pressurizing of the gas room comprises pressurizing the first gas room or the second gas room by using a pressure plate.

6. The method as claimed in claim 4, wherein the room for gas comprises a first gas room and a second gas room formed on both sides of the electrode assembly, and
wherein the pressurizing of the gas room comprises pressurizing the first gas room using a first pressurized plate and pressurizing the second gas room using a second pressurized plate.

7. The method as claimed in claim 6, wherein the first pressurized plate and the second pressurized plate are alternately used to pressurize the first gas room and the second gas room.

8. The method as claimed in claim 1, wherein the first electrode is connected to a first electrode tab and the second electrode is connected to a second electrode tab, and
wherein the gas room comprises:
a first gas room formed on a first side surface where the first electrode tab and the second electrode tab are provided; and
a second gas room formed on a second side surface opposite to the first side surface.

9. The method as claimed in claim 4, wherein the coupling of the case cover to the case comprises:
forming an edge sealing part sealed where the case and the case cover overlap, and
forming a tab sealing part extending from the edge sealing part and sealing a periphery of electrode tabs connected to the first electrode and the second electrode of the electrode assembly.

10. The method as claimed in claim 9, wherein the tab sealing part comprises a passage formed on a side surface where the electrode tabs are provided.

11. The method as claimed in claim 4, wherein the pressurizing of the gas room is performed when the case is in a horizontal plane.

12. The method as claimed in claim 4, wherein the coupling of the case cover onto the case comprises bonding the case to the case cover by thermal fusion.

13. The method as claimed in claim 4, further comprising, after pressurizing of the gas room:
tilting the case to allow gas inside the case to move upward;
perforating a surface of the case to exhaust the gas;
sealing between a part of the case from which the gas is removed in the case and another part of the case; and
cutting and removing the part of the case from which the gas is removed.

14. The method as claimed in claim 13, further comprising, after cutting and removing the part of the case from which the gas is removed:
reverse-tilting the case in a direction opposite to a direction the case was tilted;
sealing the case to separate a part that accommodates the electrode assembly from another part of the case; and
cutting and removing the another part of the case.

15. The method as claimed in claim 14, further comprising folding a sealed area that remains at an edge of the case after the another part of the case is removed.

16. The method as claimed in claim 14, wherein the sealing of the case to separate the part accommodating the electrode assembly from the another part of the case comprises:
sealing a passage formed on a side surface where an electrode tab is formed.

17. The method as claimed in claim 13, wherein the exhausting of the gas inside the case comprises:
connecting an exhaust hole formed by perforating a surface of the case to an external device, and
exhausting the gas by creating a vacuum using the external device.

18. The method as claimed in claim 1, wherein the case is formed from a pouch-type fabric.

19. The method as claimed in claim 18, wherein the case is formed from stainless use steel (SUS).

20. A battery manufactured by using the battery manufacturing method according to claim 1, wherein the battery comprises a sealing part on a side surface opposite to a side surface where an electrode tab of the battery is exposed.
